(19) United States
(12) Patent Application Publication
(10) Pub. No.: US 2025/0028870 A1
(43) Pub. Date: Jan. 23, 2025

(54) SYSTEM AND METHOD FOR AIRCRAFT ENGINE INSPECTION

(71) Applicant: MTU Aero Engines AG, Muenchen (DE)

(72) Inventors: Horst Martensen, Lindhorst (DE); Steven Walker-Knapp, Edemissen (DE); Lars Aschermann, Kalefeld (DE); Frank Seidel, Großburgwedel (DE)

(21) Appl. No.: 18/224,650

(22) Filed: Jul. 21, 2023

(51) Int. Cl. G06F 30/15; B64F 5/60

(52) U.S. Cl. CPC G06F 30/15; B64F 5/60; G06F 2119/18

(57) ABSTRACT

A method for creating a computer-implemented data system, includes: providing a virtual 3D engine model of an engine including a plurality of components; providing component-specific data associated with said each of the plurality of components; and virtually linking the virtual 3D engine model to the component-specific data by creating virtual data markers in the virtual 3D engine model at a coordinate of each of the plurality of components, and associating each virtual data marker with the component-specific data of its corresponding one of the plurality of components. In this regard, the component specific data may include, for example, part number, name, inspection intervals, etc. The engine may be an aircraft engine, and may further be an aircraft engine casing. Further, in addition to the virtual 3D engine model, the method may include providing 2D images of the plurality components, and the step of virtually linking may further include linking the 2D images to the component specific data.

### FIELD OF THE INVENTION

The present invention relates to the field of computer aided gas turbine engine inspection, and in particular aircraft turbine engine inspection.

### BACKGROUND

FR3104543A1, by DRONETIX TECHNOLOGIE SAS, discusses a positioning system for a drone system comprising a linear guide which includes a cable as well as a plurality of visual markers positioned on the cable, said cable being intended to be deployed around of an area of interest for the drone, said visual markers defining a plurality of segments on the cable. The visual markers are positioned at intervals regularly on the cable. According to FR31045433A1, the positioning system allowing the drone to inspect autonomously and precisely large objects or buildings.

DRONETIX reportedly has developed an autonomous mapping drone for industrial assets which enables automatic data capture and 3D reconstruction of small assets such as aircraft engines or landing gear.

U.S. Pat. No. 11,238,675 and its counterpart EP 3549874 A1, discuss a ground-based visual-inspection system, which includes a ground-based visual-inspection apparatus and a control system. The ground-based visual-inspection apparatus includes a mobile base, an actuatable arm coupled to the mobile base, and an effector coupled to the actuatable arm. The actuatable arm is locatable in a three dimensional space. The end effector includes a camera configured to capture images of a structure, such as an aircraft. The control system is configured to determine location information of the camera relative to a reference location and associate the location information with the images.

### SUMMARY

In accordance with a first embodiment of the present invention, a method for creating a computer-implemented data system includes: providing a virtual 3D model of an engine including a plurality of components; providing component-specific data associated with said each of the plurality of components; and virtually linking the virtual 3D model to the component-specific data by creating virtual data markers in the virtual 3D model at a coordinate of each of the plurality of components, and associating each virtual data marker with the component-specific data of its corresponding one of the plurality of components. In this regard, the component specific data may include, for example, part number, name, inspection intervals, etc. The engine may be an engine module, sub-module, casing or component of an aircraft gas turbine engine. Further, in addition to the virtual 3D model, the method may include providing 2D images of the plurality components, and the step of virtually linking may further include linking the 2D images to the component specific data.

In accordance with further embodiments of the present invention, the provision of the virtual 3D model of the first embodiment may include recording multiple 2D engine images, combining the 2D engine images to form a virtual 3D model, and virtually referencing the virtual 3D model in order to assign particular coordinates and a particular component to various image points.

In accordance with yet further embodiments of the present invention, the method according to the first embodiment may further include: storing component state information for one of the plurality of components during inspection of an engine; and creating an inspection virtual data marker at a coordinate on the virtual 3D engine model associated with component state information, and associating the inspection virtual data marker with the virtual data marker associated with said one of the plurality of components. In this regard, component state information may for example, include information on damage of a component on the inspected engine. In accordance with yet further embodiments of the present invention, the steps of storing and creating are repeated for a plurality of engines under inspection, wherein the 3D model of the engine is a 3D model of a reference engine, and the plurality of engines under inspection are of a same engine type as the reference engine, the virtual data markers being applied to the inspected engines by coordinate transformation.

In accordance with yet further embodiments of the present invention, a computer-implemented data system that is provided according to one or more the methods described above.

In accordance with yet further embodiments of the present invention, the computer-implemented data system or methods according to the above embodiments are used for tele repair, remote maintenance, assessment, evaluation, virtual measurement, documentation, representation, and evaluation of engine and/or component information.

### BRIEF DESCRIPTION OF DRAWING

FIG. 1 is a schematic representation of the a system according to an embodiment of the present invention;

FIG. 2 is a flow chart for the system of FIG. 1.

### DETAILED DESCRIPTION

In order to document the external condition of an aircraft engine at inbound/outbound delivery, a visual inspection is generally carried out, and additional photographs or videos are optionally produced, using a standard camera. Damage to accessory equipment, lines, cables, plugs, etc., may be easily overlooked and possibly not recorded. After inbound/outbound delivery takes place and complaints are subsequently made, this may result in undesirable subrogation discussions. A system-supported scanning/inspection process with simultaneous documentation of damage and missing parts presently does not take place.

Large objects (buildings, bridges, aircraft) are known to be inspected using drones equipped with cameras. There are also mobile scanning robots. It is also conceivable to use specialized portals or lock units in which a 360° optical detection of the outer casing takes place. However, these systems do not meet the challenge of recording the engine in the operating environment or in the environment of the repair shop surroundings.

In the maintenance, repair, and overhaul (MRO) and in original equipment manufacturer (OEM) processes, a holistic view of the engine and its components is often necessary. This includes an inspection and documentation of the outer casing of engines (including all fixtures) to identify missing parts, damage, and leaks under all installation, storage, and transport conditions. A method which is simple, rapid, and implementable at various sites, would be very advantageous.

Inspections are carried out frequently (inbound delivery, induction, transfer to a test stand, prior to shipment, upon arrival by the airline, prior to shipment to an MRO shop). For MRO, it is important to detect damage and missing parts upon inbound delivery so that it is possible to order replacement parts or to record transport damage, if necessary, as soon as possible. Likewise, an unequivocal documentation of the outbound delivery/transfer of an undamaged engine to the customer is very advantageous from both a customer service standpoint and a legal standpoint. It is important to carry out the documentation based on OEM data. This is because CAD (Computer-Aided Design) data or other source data of the OEM are not present or are available only in the form of the general engine documentation.

In accordance with various embodiments of the present invention, a methodology for assigning these data to the 3D space of the digital twin (e.g. a 3-D digital model of the engine), and thus for carrying out the conventional MRO inspection procedures in the incoming inspection report and the outgoing inspection report, is provided. This methodology may be applied to all types of gas turbines. By use of this methodology, assistance may be provided in the event of missing engine parts, damage to engine components, and a subsequent damage analysis, also using AI (Artificial Intelligence), repair support, and component ordering in MRO and AOG (Aircraft on the Ground) operations.

The 3-D digital model of the reference engine (the digital twin of the engine to be inspected) may be prepared by scanning a reference engine using a digital scanner to obtain high-resolution 2 dimensional (2D) image data, as well as 3 dimensional (3-D) data for subsequent navigation, and combining the 2D images and 3D data to form a 3D digital model of the reference engine, which is stored in a database along with the 2D images and 3D data.

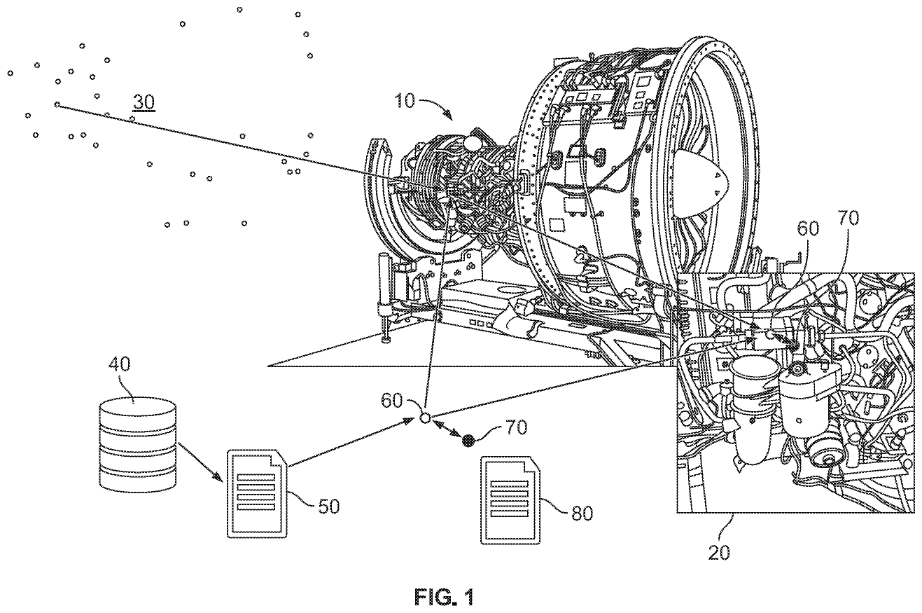

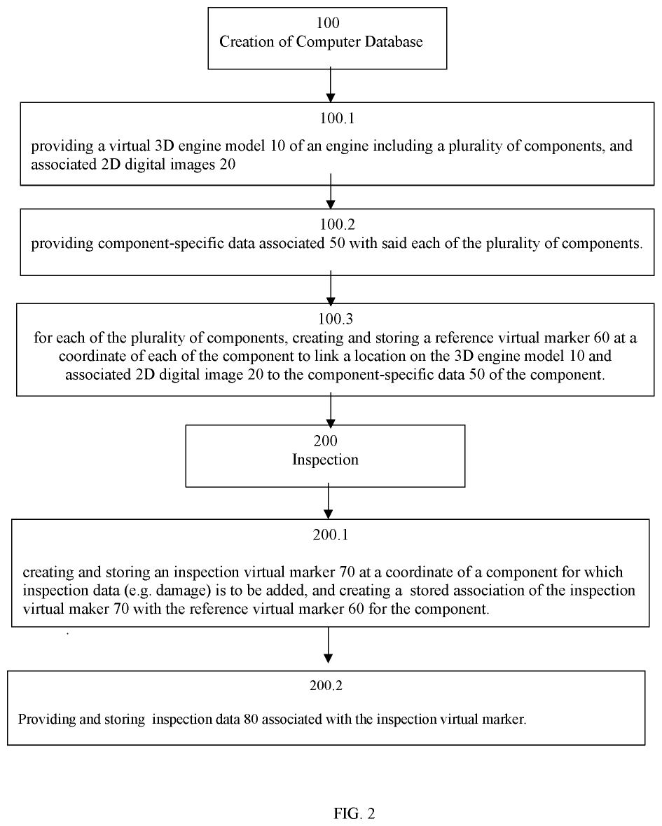

FIG. 1 illustrates an exemplary system according to an embodiment of the present invention, including the 3-D digital model 10 and one of the 2-D Digital images 20. FIG. 2 is an illustrative flow chart, wherein step 100.1 recites the provision of 3-D digital model 10 and associated 2-D digital images 20.

In order to utilize the 3-D digital model (or digital twin) in MRO or OEM engine inspection, it is necessary to provide a linkage of the image data in the digital twin to the OEM data that describe the component. This linkage is used to provide a 3-D reference point system 30.

For data storage and digitization of the OEM data, a database system 40, in which the OEM data are stored based on a component number of the OEM part, may be used. As an example, the database system may include an engine parts list, including: part number, name, as well as inspection intervals associated with the parts, reference to the engine manual associated with the parts, the engine version number associated with the parts, and other information.

The stored OEM data is superimposed on the digital twin (reference engine) with spatial resolution. In this regard, the set of OEM data 50 is superimposed on the digital twin (10, 20) by assigning a reference virtual data marker 60 to each part on the 3-D digital model 10 and on the associated 2-D digital image 20, and then linking the reference virtual data markers 60 to the OEM data set 50, so that each reference virtual marker 60 is associated with a corresponding OEM part in the OEM data set 50 (steps 100.2 and 100.3). Together, this provides a 3-D reference point system which links OEM data 50 to specific locations on the 3-D digital model 10 and 2-D digital images 20 for a reference engine. This can be done for various engine types.

The reference virtual markers 60 of the 3D reference point system are then applied to the live data of a 3D data recording of an engine for which inspection is pending. In this manner, the virtual markers are transferred to the engine under inspection by a coordinate transformation. As explained previously, the reference points (i.e., the reference virtual markers 60) are not only coupled in 3D space (10), but are also transferred to the component in the 2D engine view 20, as illustrated. The engine inspection can then be imageable in the 3D and 2D image view 10, 20. In particular, damage, etc., is annotated in 3D and 2D by applying an inspection virtual marker 70 to the 3D digital model 10 and the associated 2D digital image 20 (step 200.1), and adding associated information as inspection data 80 (step 200.2). An association is stored between the virtual marker 70 and its associated virtual marker 60, either in step 200.1, or later. By selecting the corresponding reference virtual marker 60 to the inspection virtual marker 70 (i.e. the marker 60 associated with the damaged part identified by the marker 70), the inspection data 80 may now be coupled to the OEM component data set 50. Thus, CAD data are no longer necessary for any of the work steps. However, damage or the like is representable in the virtual map of the engine (10, 20), and at the same time is present in the database (40, 50, 80) in order to plan a repair or the like on the component. In addition, the markers 60, 70 and the virtual image data 10, 20 may be prepared and discussed with external or internal customers.

Furthermore, with the database, including the 3-D digital model 10, the 2D images 20, and the linked OEM and inspection data (30, 40, 50, 60, 70, 80), it is possible to analyze the damage profiles over an engine family or perform other evaluations, through the use of AI technology and/or data mining. The OEM and Inspection data sets (40, 50, 80), linked (30, 60, 70) with the image data (10, 20) may be further utilized for repair instructions and trainings. The database may also be used in the field of augmented reality by combining the virtual data with a live image of the engine under inspection.

This is particularly important in the MRO environment, since originally used CAD data (which would otherwise be available to create a 3-D engine model) are not available in the MRO environment. Via the data utilization, it is also possible to assist with repairs in an AOG operation over large distances via a “telemedicine” function, in that the mechanic may be guided on site. The possibilities may also be transferred to the engine modules and individual parts, and states within the scope of an engine overhaul may thus be documented. Further, if sufficient accuracy is present in the image data, metrological documentations at the component may also be provided.

By use of the present invention, a digital inspection of engines based on 3D and/or 2D data sets is possible in the MRO without using CAD or image data of the OEM for this purpose. Processing of the data within the scope of the digital twin is thus made possible over the entire set of master data, and the image information is coupled to the information about the component (e.g., data from the engine manual). In the event of engine disassembly, this same methodology may likewise be applied to the modules and individual components. In this way, the life cycle data (image/component) concerning the life of the engine may be subsequently recorded and documented. Using the methodology of the present invention, the repair steps may be virtually discussed with internal and external customers. This reduces disruptions in the overhaul process, decreases throughput times of an engine, and improves communication via the eye-catching use of graphical representation. In addition, recurring errors/damage may be automatically evaluated in order to provide customers with information, within the scope of trend monitoring, for the next due maintenance interval.

It should also be appreciated that the exemplary embodiments are only examples, and are not intended to limit the scope, applicability, or configuration in any way. Rather, the foregoing detailed description provides those skilled in the art with a convenient road map for implementing at least one exemplary embodiment, it being understood that various changes may be made in the function and arrangement of elements described without departing from the scope of protection as is derived from the claims and the combinations of features equivalent thereto.

What is claimed is:

1. A method for creating a computer-implemented data system, including the steps:
providing a virtual 3D model of an engine including a plurality of components;
providing component-specific data associated with said each of the plurality of components;
virtually linking the virtual 3D model to the component-specific data by creating virtual data markers in the virtual 3D model at a coordinate of each of the plurality of components, and associating each virtual data marker with the component-specific data of its corresponding one of the plurality of components.

2. The method of claim 1, wherein the engine is a gas turbine engine.

3. The method of claim 1, wherein the engine is an engine module, sub-module, casing or component of an aircraft gas turbine engine.

4. The method of claim 1, wherein the component specific data includes at least one of a part number and a part name.

5. The method of claim 1, wherein the providing the virtual 3D model, includes providing the virtual 3D model without using CAD data.

6. The method of claim 1, wherein the provision of the virtual 3D model includes:
recording multiple 2D images,
combining the 2D images to form a virtual 3D model,
virtually referencing the virtual 3D model in order to assign particular coordinates and a particular component to various image points.

7. The method of claim 1, wherein the step of providing further includes providing 2D images of the plurality components, and the step of virtually linking further includes linking the 2D images to the component specific data.

8. The method of claim 1, further including:
storing component state information for one of the plurality of components during inspection of an engine;
creating an inspection virtual data marker at a coordinate on the virtual 3D model associated with component state information, and associating the inspection virtual data marker with the virtual data marker associated with said one of the plurality of components.

9. The method of claim 8, wherein the steps of storing and creating are repeated for a plurality of engines under inspection, wherein the 3D model of the engine is a 3D model of a reference engine, and the plurality of engines under inspection are of a same engine type as the reference engine, the virtual data markers being applied to the inspected engines by coordinate transformation.

10. A computer-implemented data system that is provided according to a method of the preceding claims.

11. Use of a computer-implemented data systems according to one of the preceding claims for tele repair, remote maintenance, assessment, evaluation, virtual measurement, documentation, representation, and evaluation of engine and/or component information.
